(19) United States
(12) Patent Application Publication
(10) Pub. No.: US 2023/0043766 A1
(43) Pub. Date: Feb. 9, 2023

(54) IMAGE PROCESSING METHOD, ELECTRONIC DEVICE AND COMPUTER STORAGE MEDIUM

(71) Applicant: BEIJING BAIDU NETCOM SCIENCE TECHNOLOGY CO., LTD., Beijing (CN)

(72) Inventors: Ruizhi CHEN, Beijing (CN); Chen ZHAO, Beijing (CN)

(73) Assignee: BEIJING BAIDU NETCOM SCIENCE TECHNOLOGY CO., LTD., Beijing (CN)

(21) Appl. No.: 17/875,519

(22) Filed: Jul. 28, 2022

(30) Foreign Application Priority Data
Aug. 4, 2021 (CN) 202110892854.5

(51) Int. Cl. G06T 19/20; G06T 17/20

(52) U.S. Cl. CPC G06T 19/20; G06T 17/20; G06T 2200/24; G06T 2219/2021

(57) ABSTRACT

An image processing method, an electronic device and a computer storage medium are provided, which relates to the fields of computer vision, augmented reality and artificial intelligence technologies. An implementation includes: acquiring a to-be-processed face image; reconstructing a face based on the to-be-processed face image to obtain a first blend coefficient vector based on a first blendshape base group; mapping the first blend coefficient vector to a second blendshape base group according to a pre-obtained coefficient mapping matrix between the first blendshape base group and the second blendshape base group to obtain a second blend coefficient vector based on the second blendshape base group; acquiring input face adjustment information, the face adjustment information including second blendshape base information; and obtaining a target face image based on the second blendshape base information and the second blend coefficient vector.

### CROSS-REFERENCE TO RELATED APPLICATIONS

The present application claims the priority of Chinese Patent Application No. 202110892854.5, filed on Aug. 4, 2021, with the title of “IMAGE PROCESSING METHOD AND APPARATUS, DEVICE AND COMPUTER STORAGE MEDIUM.” The disclosure of the above application is incorporated herein by reference in its entirety.

### FIELD OF THE DISCLOSURE

The present disclosure relates to the field of image processing technologies, and particularly to the fields of computer vision, augmented reality and artificial intelligence technologies.

### BACKGROUND OF THE DISCLOSURE

With a development of image processing technologies and a continuous improvement of requirements of people for interest of products, an application of virtual characters is increasingly extensive. For example, in a live broadcast scenario, a real character of an anchor is replaced with a virtual character to perform a live video broadcast. For another example, in a human-computer interaction scenario, a virtual character is used for simulating a real person to interact with a user.

A virtual character matched with an input face image may be generated according to the face image, but a face editing technology for the generated virtual character is urgently required to be improved.

### SUMMARY OF THE DISCLOSURE

In view of this, the present disclosure provides an image processing method, an electronic device and a computer storage medium, which improve flexibility of editing a face of a virtual character.

According to a first aspect of the present disclosure, there is provided an image processing method, including acquiring a to-be-processed face image; reconstructing a face based on the to-be-processed face image to obtain a first blend coefficient vector based on a first blendshape base group; mapping the first blend coefficient vector to a second blendshape base group according to a pre-obtained coefficient mapping matrix between the first blendshape base group and the second blendshape base group to obtain a second blend coefficient vector based on the second blendshape base group; acquiring input face adjustment information, the face adjustment information including second blendshape base information; and obtaining a target face image based on the second blendshape base information and the second blend coefficient vector.

According to a second aspect of the present disclosure, there is provided an electronic device, including at least one processor; and a memory communicatively connected with the at least one processor; wherein the memory stores instructions executable by the at least one processor, and the instructions are executed by the at least one processor to enable the at least one processor to perform an image processing method, wherein the image processing method includes acquiring a to-be-processed face image; reconstructing a face based on the to-be-processed face image to obtain a first blend coefficient vector based on a first blendshape base group; mapping the first blend coefficient vector to a second blendshape base group according to a pre-obtained coefficient mapping matrix between the first blendshape base group and the second blendshape base group to obtain a second blend coefficient vector based on the second blendshape base group; acquiring input face adjustment information, the face adjustment information including second blendshape base information; and obtaining a target face image based on the second blendshape base information and the second blend coefficient vector.

According to a third aspect of the present disclosure, there is provided anon-transitory computer readable storage medium with computer instructions stored thereon, wherein the computer instructions are used for causing a computer to perform an image processing method, wherein the image processing method includes acquiring a to-be-processed face image; reconstructing a face based on the to-be-processed face image to obtain a first blend coefficient vector based on a first blendshape base group; mapping the first blend coefficient vector to a second blendshape base group according to a pre-obtained coefficient mapping matrix between the first blendshape base group and the second blendshape base group to obtain a second blend coefficient vector based on the second blendshape base group; acquiring input face adjustment information, the face adjustment information including second blendshape base information; and obtaining a target face image based on the second blendshape base information and the second blend coefficient vector.

It should be understood that the statements in this section are not intended to identify key or critical features of the embodiments of the present disclosure, nor limit the scope of the present disclosure. Other features of the present disclosure will become apparent from the following description.

### BRIEF DESCRIPTION OF DRAWINGS

The drawings are used for better understanding the present solution and do not constitute a limitation of the present disclosure. In the drawings,

FIG. 1 is a flow chart of a main method according to an embodiment of the present disclosure;

FIG. 2 is an instance diagram of a first blendshape base group according to an embodiment of the present disclosure;

FIG. 3 is an instance diagram of a second blendshape base group according to an embodiment of the present disclosure;

FIG. 4 is a structural diagram of an image processing apparatus according to an embodiment of the present disclosure; and

FIG. 5 is a block diagram of an electronic device configured to implement the embodiment of the present disclosure.

### DETAILED DESCRIPTION OF PREFERRED EMBODIMENTS

The following part will illustrate exemplary embodiments of the present disclosure with reference to the drawings, including various details of the embodiments of the present disclosure for a better understanding. The embodiments should be regarded only as exemplary ones. Therefore, those skilled in the art should appreciate that various changes or modifications can be made with respect to the embodiments described herein without departing from the scope and spirit of the present disclosure. Similarly, for clarity and conciseness, the descriptions of the known functions and structures are omitted in the descriptions below.

The terminology used in the disclosed embodiments is for the purpose of describing particular embodiments only and is not intended to limit the present disclosure. As used in the embodiments of the present disclosure and the appended claims, the singular forms “a”, “the”, and “this” are intended to include the plural forms as well, unless the context clearly indicates otherwise.

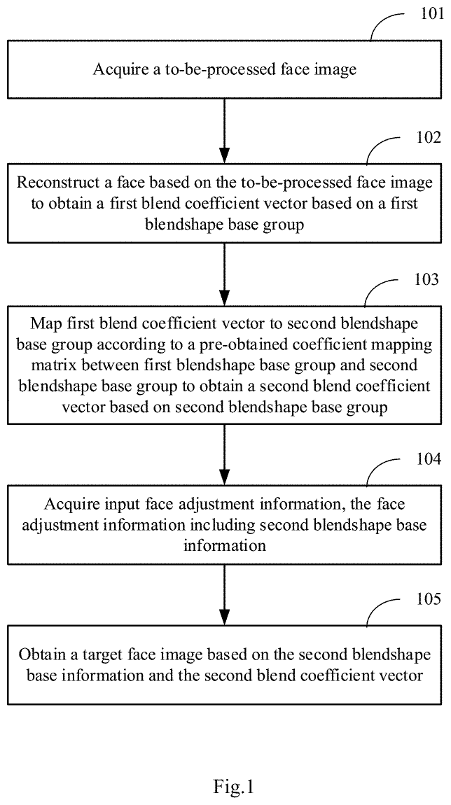

FIG. 1 is a flow chart of a main method according to an embodiment of the present disclosure; an execution subject of the method is an image processing apparatus, and the apparatus may be configured as an application located at a server, or a functional unit, such as a plug-in or software development kit (SDK) located in the application of the server, or the like, or be located at a computer terminal with high computing power, which is not particularly limited in the embodiment of the present application. As shown in FIG. 1, the method may include:

101: acquiring a to-be-processed face image;

102: reconstructing a face based on the to-be-processed face image to obtain a first blend coefficient vector based on a first blendshape base group;

103: mapping the first blend coefficient vector to a second blendshape base group according to a pre-obtained coefficient mapping matrix between the first blendshape base group and the second blendshape base group to obtain a second blend coefficient vector based on the second blendshape base group;

104: acquiring input face adjustment information, the face adjustment information including second blendshape base information; and

105: obtaining a target face image based on the second blendshape base information and the second blend coefficient vector.

From the above technical solution, the present disclosure provides an image processing technology capable of conveniently and flexibly editing a face. The above steps will be described below in detail in conjunction with an embodiment.

It should be noted here that the “first”, “second”, etc. involved in the embodiments of the present disclosure do not mean restrictions in terms of order, size, quantity, etc., but are only used to distinguish names. For example, the “first blendshape base group” and the “second blendshape base group” are used to distinguish the two blendshape base groups. For another example, the “first blend coefficient vector” and the “second blend coefficient vector” are used to distinguish the two vectors.

First, the above step 101 of acquiring a to-be-processed face image is described in detail in conjunction with the embodiment.

In the embodiment of the present disclosure, the obtained to-be-processed face image is an image including a face, and may include one or more faces. If the image includes plural faces, the processing method according to the embodiment of the present disclosure may be performed on one of the faces designated by a user, or on all the included faces.

The to-be-processed face image may be a gray image or a color image. The to-be-processed face image acquired in the present disclosure is a two-dimensional face image.

As one implementation, the to-be-processed face image may be acquired by an image collection apparatus in real time; for example, the user takes a picture of the face in real time using the image collection apparatus, such as a digital camera, a camera of an intelligent terminal, a web camera, or the like, to obtain the to-be-processed face image.

As another implementation, a stored image containing the face may be locally acquired from a user terminal as the to-be-processed face image. For example, the user locally acquires the stored to-be-processed face image from a computer terminal, a smart phone, a tablet computer, and other devices.

The to-be-processed face image may be an originally acquired face image or a face image after a related preprocessing operation. The preprocessing operation may include, for example, scaling, format conversion, image enhancement, noise reduction filtration, image correction, or the like.

The above step 102 of reconstructing a face based on the to-be-processed face image to obtain a first blend coefficient vector based on a first blendshape base group will be described below in detail in conjunction with an embodiment.

In order to facilitate the understanding of this step, the blendshape is explained first.

A face expression of the blendshape is a core link of a face reconstruction technology, which is a technology of transforming a single mesh to realize a combination of many predefined shapes and any number. For example, the single mesh is a basic shape (for example, an expressionless face) of a default shape, and other shapes of the basic shape are used for blending, and are different expressions (smiling, frowning and eyelid closing), and these shapes are collectively referred to as blendshapes.

Face reconstruction refers to the reconstruction of a three-dimensional model of the face from one or more two-dimensional images. The three-dimensional model M of the face may be expressed as:

M=(S,T) (1)

wherein S is a face shape vector, and T is a face texture vector. Only the face shape vector is involved and concerned in the present disclosure.

For a specific face shape, a face reconstruction result may be acquired by weighting different blendshape bases. Each base includes coordinates of a plurality of three-dimensional key points on the face. The three-dimensional key points are the key points of the face in a three-dimensional space. For example, the three-dimensional key points may be the key points of the face with high expression abilities, such as the eyes, the outer contour of the face, the nose, the eyebrows, the canthi, the mouth, the chin, or the like. One blendshape base corresponds to one face shape. The different blendshape bases used for the face in this step are referred to as the first blendshape base group. The face shape obtained by reconstructing the face may be expressed as the following formula:

$$S 1 = \overline{S} + {\sum }_{i = 1}^{m} {α}_{i}^{1} ( {s}_{i}^{1} - \overline{S} ) \qquad ( 2 )$$

wherein S̅ is a vector of an average face base. The first blendshape base group contains m blendshape bases, and the vector corresponding to the base is expressed as Sᵢ¹. αᵢ¹ is a weighting coefficient corresponding to the m bases, and the weighting coefficients corresponding to all the bases constitute the first blend coefficient vector α¹. In this and subsequent formulas, superscripts 1 and 2 represent the first blendshape base group and the second blendshape base group respectively.

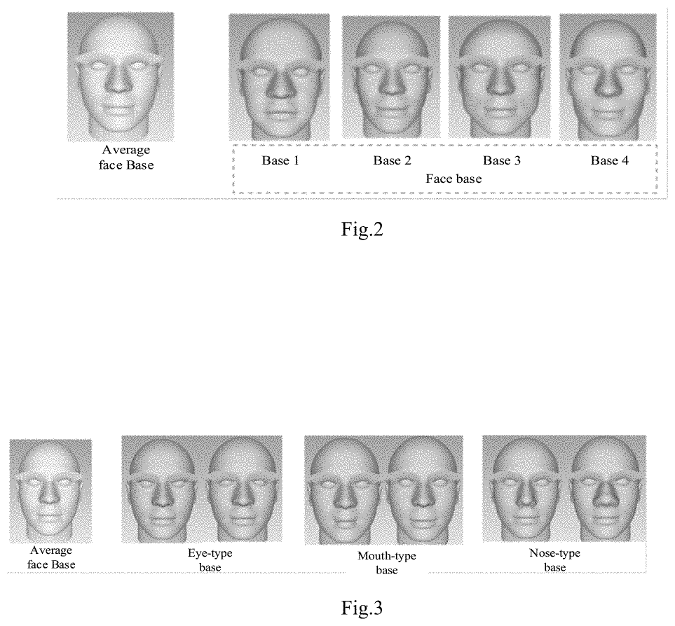

For example, as shown in FIG. 2, the first blendshape base group includes the average face base and four other face bases base1-base4, a vector corresponding to the average face base is S̅, and vectors corresponding to the four other face bases are s₁¹-s₄¹. Each face base corresponds to one weighting coefficient which is expressed as α₁¹-a₄¹. Then, the face shape may be expressed as:

S1=S̅+α₁¹*(s₁¹−S̅)+α₂¹*(s₂¹−S̅)+α₃¹*(s₃¹−S̅)−α₄¹*(s₄¹−S̅) (3)

The faces of different shapes may be generated by changing the weighting coefficients, and actually, the process of reconstructing the face is a process of fitting the face shape using the first blendshape base group. Based on the first blendshape base group, different face shapes may correspond to different first blend coefficient vectors; that is, one face shape may be expressed by the first blend coefficient vector.

The first blendshape base group in the embodiment of the present disclosure may be, but is not limited to, a Basel face model (BFM) and a Facewarehouse (FWH).

Blendshapes of most blendshape bases used in the academia are extracted by collecting face scanning data in batches and using PCA. The base constructed in this way has high expressive force, and although facial types and facial features have slight changes among different bases, the facial types and the facial features are difficult to correspond to specific semantic information. For example, the facial type base shown in FIG. 2 is difficult to specifically describe by semantics, such as a “long face”, a “round face”, “almond eyes”, “phoenix eyes”, or the like, which is not favorable for the user to adjust the generated face shapes.

Currently, specific algorithms for face reconstruction are mature, and include a reconstruction algorithm based on face key points and a face reconstruction algorithm based on deep learning. Therefore, the specific algorithms will not be described in detail here.

The above step 103 of mapping the first blend coefficient vector to a second blendshape base group according to a pre-obtained coefficient mapping matrix between the first blendshape base group and the second blendshape base group to obtain a second blend coefficient vector based on the second blendshape base group will be described below in detail in conjunction with an embodiment.

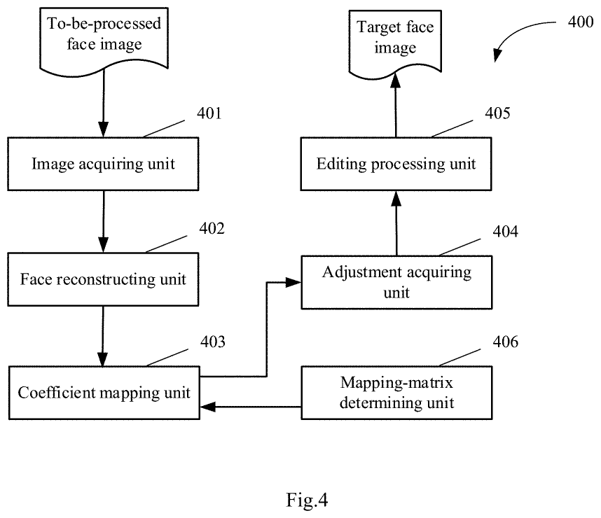

The “second blendshape base group” is involved in this step, and in order to facilitate the user to edit the face, a semantics-based blendshape base group may be pre-designed as the second blendshape base group. The second blendshape base group may include blendshape bases of more than one semantic type. For example, as shown in FIG. 3, the second blendshape base group may include an eye-type base, a mouth-type base and a nose-type base in addition to the average face base. Each semantic type may contain plural bases, and in FIG. 3, for example, each semantic type contains only two bases. In practical applications, semantics is generally divided more finely. For example, the facial types include a wide face, a narrow face, a long face and a short face; eye positions include high, low, front, rear, wide, narrow positions; canthus types include an upward inner canthus, a downward outer canthus, or the like; mouth types include a large mouth, a small mouth, a high mouth, a low mouth, or the like; nose types include a wide nose, a narrow nose, a large nose, a small nose, or the like; eyebrow types include thick eyebrows, thin eyebrows, wide eyebrows, narrow eyebrows, or the like.

In the present disclosure, a coefficient mapping operation may be performed on the first blendshape base group and the second blendshape base group in advance to obtain the coefficient mapping matrix. A least-square mapping strategy may be used for the coefficient mapping operation; for example, the coefficient mapping matrix M may be expressed as:

M=(M_{b}^{T}·M_{b})⁻¹M_{b}^{T}·Mₐ (4)

wherein Mₐ is a first blendshape matrix corresponding to the first blendshape base group, and M_{b} is a blendshape matrix corresponding to the second blendshape base group. The blendshape matrix is formed by differences between all the bases in the blendshape base group and the average face base.

Mₐ=(s₁¹−S̅, s₂¹−S̅, . . . , sₘ¹−S̅), wherein m is the number of the bases in the first blendshape base group. =(s₁²−S̅, s₂²−S̅, . . . , sₙ²−S̅), wherein n is the number of the bases in the second blendshape base group. The first blendshape base group and the second blendshape base group share the same average face base.

That is, the coefficient mapping matrix is acquired by: acquiring the preset first and second blendshape base groups; acquiring the first blendshape matrix of the first blendshape base group compared to the average face base and a second blendshape matrix of the second blendshape base group compared to the average face base; and obtaining the coefficient mapping matrix between the first blendshape base group and the second blendshape base group using the first blendshape matrix and the second blendshape matrix, as shown in formula (4), for example.

During execution of the step 103, the second blend coefficient vector may be determined by the product of the coefficient mapping matrix and the first blend coefficient vector.

For example, the second blend coefficient vector α² may be:

α²=M*α¹ (5)

wherein M is the coefficient mapping matrix, and α¹ is the first blend coefficient vector.

The above step 104 of acquiring input face adjustment information, the face adjustment information including second blendshape base information, will be described below in detail in conjunction with an embodiment.

As one implementation, the user may input the face adjustment information by inputting an instruction, for example, inputting a code, a sentence, or the like, to set the second blendshape base information.

Another preferred implementation may include: providing an interactive interface for the user, and showing selectable second blendshape base information to the user by the interactive interface; and acquiring the face adjustment information input by the user using the interactive interface, the face adjustment information including the second blendshape base information selected by the user.

The second blendshape base information includes semantic information to be specifically adjusted by the user. For example, if the user wants to adjust the facial type, the second blendshape base information includes base information corresponding to a specific facial type set or selected by the user. For another example, if the user wants to adjust the nose type, the second blendshape base information includes base information corresponding to a specific nose type set or selected by the user. The base information may be specific information, such as a base identification, a name, or the like.

The above step 105 of obtaining a target face image based on the second blendshape base information and the second blend coefficient vector will be described below in detail in conjunction with an embodiment.

One preferred implementation may specially include the following steps:

step 1051: determining a semantic type of the second blendshape base information.

As mentioned in the above embodiments, the designed second blendshape base group generally includes plural semantic types, such as the mouth types, the nose types, the facial types, or the like. Therefore, the semantic type corresponding to the second blendshape base information input by the user is required to be determined.

However, if the second blendshape base group only includes one semantic type, this step may not be executed.

Step 1052: updating the coefficient at a position corresponding to the second blendshape base information in the second blend coefficient vector to a valid value, and updating the coefficient at another position corresponding to the determined semantic type in the second blend coefficient vector to an invalid value.

Since the second blend coefficient vector of the to-be-processed face image based on the second blendshape base group is obtained in step 103, the second blendshape base information input by the user is semantic information to be adjusted by the user, which includes a shape the user wishes to set for specific semantics. Therefore, the coefficient at the position corresponding to the second blendshape base information in the second blend coefficient vector is updated to the valid value, for example, set to 1. The other shapes corresponding to the semantic information in the second blend coefficient vector are shapes not adopted by the user, such that the coefficient at the other position corresponding to the determined semantic type in the second blend coefficient vector is updated to the invalid value, for example, set to 0.

For example, it is assumed that the second blend coefficient vector is [α₁², α₂², α₃², α₄², α₅², α₆²], wherein α₁² and α₂² are weighting coefficients corresponding to two eye types included in the eye-type base, α₃² and α₄² are weighting coefficients corresponding to two mouth types included in the mouth-type base, and α₅² and α₆² are weighting coefficients corresponding to two nose types included in the nose-type base. If the user wants to adjust the nose type, and selects one of the nose types, and the nose type corresponds to the position of α₅², α₅² is set to 1, and α₆² is set to 0. The coefficients corresponding to the other semantics are unchanged.

Step 1053: obtaining the target face image using the updated second blend coefficient vector.

In this step, on the basis of the average face base, the updated second blend coefficient vector may be used to weight each base in the second blendshape base group, so as to obtain the target face image. That is, the face shape in the target face image may be obtained with this step.

The target face shape S′ may be:

$${S}^{′} = \overline{S} + {\sum }_{i = 1}^{n} {α}_{i}^{2} ( {s}_{i}^{2} - \overline{S} ) \qquad ( 6 )$$

As a typical application scenario, the target face image may be a virtual character. Then, an initial virtual character may be obtained after step 102 based on the to-be-processed face image according to the above embodiment. Then, the user may conveniently edit the face in the virtual shape using the steps 103-105 for the specific semantics. For example, specific facial types, mouth types, eye types, nose types, or the like, are adjusted.

As a typical system framework, a user device sends the to-be-processed face image to the server after collecting the to-be-processed face image, and the server executes each flow in the method embodiments. During the above flows, the server may send the interactive interface to the user device. The user device provides the interactive interface for the user, and the user inputs the face adjustment information by the interactive interface, and sends the face adjustment information to the server. The target face image generated by the server finally may be returned to the user device for display.

The user device may be a smart mobile device, a smart home device, a wearable device, a personal computer (PC), or the like. The smart mobile device may include a mobile phone, a tablet computer, a notebook computer, a personal digital assistant (PDA), an internet car, or the like. The smart home device may include a smart appliance device, such as a smart television, a smart refrigerator, a smart camera, or the like. The wearable device may include a smart watch, smart glasses, a virtual reality device, an augmented reality device, a mixed reality device (i.e., devices which may support both virtual reality and augmented reality), and so on.

The embodiment of the present disclosure actually discloses a face expression system framework based on double blendshape base groups, and makes full use of expression characteristics of the different blendshape base groups. For example, if the first blendshape base group has characteristics of high expressive force and fine depiction of the face, and the second blendshape base group has the characteristic of semantic expression, the image processing method according to the present disclosure may expand semantic flexibility of face editing while guaranteeing reconstruction precision of the face.

The method according to the present disclosure is described above in detail, and an apparatus according to an embodiment of the present disclosure will be described below in detail in conjunction with an embodiment.

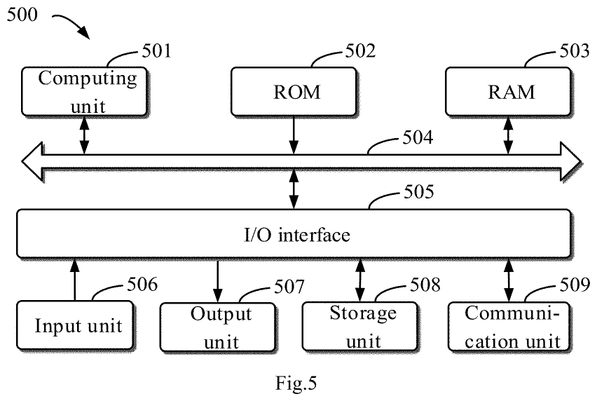

FIG. 4 is a structural diagram of an image processing apparatus according to an embodiment of the present disclosure, and as shown in FIG. 4, the apparatus may include an image acquiring unit 401, a face reconstructing unit 402, a coefficient mapping unit 403, an adjustment acquiring unit 404 and an editing processing unit 405, and may further include a mapping-matrix determining unit 406. The main functions of each constitutional unit are as follows.

The image acquiring unit 401 is configured to acquire a to-be-processed face image.

As one implementation, the to-be-processed face image may be acquired by an image collection apparatus in real time; for example, a user takes a picture of the face in real time using the image collection apparatus, such as a digital camera, a camera of an intelligent terminal, a web camera, or the like, to obtain the to-be-processed face image.

As another implementation, a stored image containing the face may be locally acquired from a user terminal as the to-be-processed face image. For example, the user locally acquires the stored to-be-processed face image from a computer terminal, a smart phone, a tablet computer, and other devices.

The to-be-processed face image may be an originally acquired face image or a face image after a related preprocessing operation. The preprocessing operation may include, for example, scaling, format conversion, image enhancement, noise reduction filtration, image correction, or the like.

The face reconstructing unit 402 is configured to reconstruct a face based on the to-be-processed face image to obtain a first blend coefficient vector based on a first blendshape base group.

The first blend coefficient vector is formed by weighting coefficients of all bases in the first blendshape base group obtained by face reconstruction.

Currently, specific algorithms for face reconstruction are mature, and include a reconstruction algorithm based on face key points and a face reconstruction algorithm based on deep learning. Therefore, the specific algorithms will not be described in detail here.

The coefficient mapping unit 403 is configured to map the first blend coefficient vector to a second blendshape base group according to a pre-obtained coefficient mapping matrix between the first blendshape base group and the second blendshape base group to obtain a second blend coefficient vector based on the second blendshape base group.

The second blend coefficient vector may be determined using the above formula (5).

The adjustment acquiring unit 404 is configured to acquire input face adjustment information, the face adjustment information including second blendshape base information.

The editing processing unit 405 is configured to obtain a target face image based on the second blendshape base information and the second blend coefficient vector.

As one implementation, the second blendshape base group is a semantics-based blendshape base group, and includes blendshape bases of more than one semantic type. The semantic types may include, for example, facial types, eye types, nose types, mouth types, eyebrow types, or the like.

Still further, the apparatus may include the mapping-matrix determining unit 406 configured to obtain the coefficient mapping matrix in advance by acquiring the preset first blendshape base group and second blendshape base group; acquiring a first blendshape matrix of the first blendshape base group compared to an average face base and a second blendshape matrix of the second blendshape base group compared to the average face base; and obtaining the coefficient mapping matrix between the first blendshape base group and the second blendshape base group using the first blendshape matrix and the second blendshape matrix.

For example, the coefficient mapping matrix may be obtained using the formula (4) in the method embodiment.

As one preferred implementation, the adjustment acquiring unit 404 is specifically configured to show selectable second blendshape base information to the user by an interactive interface; and acquire the face adjustment information input by the user using the interactive interface, the face adjustment information including the second blendshape base information selected by the user.

In addition, the user may also input the face adjustment information by inputting an instruction, for example, inputting a code, a sentence, or the like, to set the second blendshape base information.

As one implementation, the editing processing unit 405 is specifically configured to determine a semantic type of the second blendshape base information; update a coefficient at a position corresponding to the second blendshape base information in the second blend coefficient vector to a valid value, and update a coefficient at another position corresponding to the determined semantic type in the second blend coefficient vector to an invalid value, wherein the valid value may be, for example, 1 and the invalid value may be, for example, 0; and obtain the target face image using the updated second blend coefficient vector.

The embodiments in the specification are described progressively, and mutual reference may be made to same and similar parts among the embodiments, and each embodiment focuses on differences from other embodiments. In particular, since the apparatus embodiment is substantially similar to the method embodiment, the description is relatively simple, and reference may be made to the corresponding description of the method embodiment for relevant points.

In the technical solution of the present disclosure, the acquisition, storage and application of involved user personal information are in compliance with relevant laws and regulations, and do not violate public order and good customs.

According to the embodiment of the present disclosure, there are also provided an electronic device, a readable storage medium and a computer program product.

FIG. 5 is a block diagram of an electronic device configured to implement an image processing method according to the embodiment of the present disclosure. The electronic device is intended to represent various forms of digital computers, such as laptop computers, desktop computers, workstations, personal digital assistants, servers, blade servers, mainframe computers, and other appropriate computers. The electronic device may also represent various forms of mobile apparatuses, such as personal digital assistants, cellular telephones, smart phones, wearable devices, and other similar computing apparatuses. The components shown herein, their connections and relationships, and their functions, are meant to be exemplary only, and are not meant to limit implementation of the present disclosure described and/or claimed herein.

As shown in FIG. 5, the device 500 includes a computing unit 501 which may perform various appropriate actions and processing operations according to a computer program stored in a read only memory (ROM) 502 or a computer program loaded from a storage unit 508 into a random access memory (RAM) 503. Various programs and data necessary for the operation of the device 500 may be also stored in the RAM 503. The computing unit 501, the ROM 502, and the RAM 503 are connected with one other through a bus 504. An input/output (I/O) interface 505 is also connected to the bus 504.

The plural components in the device 500 are connected to the I/O interface 505, and include: an input unit 506, such as a keyboard, a mouse, or the like; an output unit 507, such as various types of displays, speakers, or the like; the storage unit 508, such as a magnetic disk, an optical disk, or the like; and a communication unit 509, such as a network card, a modem, a wireless communication transceiver, or the like. The communication unit 509 allows the device 500 to exchange information/data with other devices through a computer network, such as the Internet, and/or various telecommunication networks.

The computing unit 501 may be a variety of general and/or special purpose processing components with processing and computing capabilities. Some examples of the computing unit 501 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, or the like. The computing unit 501 performs the methods and processing operations described above, such as the image processing method. For example, in some embodiments, the image processing method may be implemented as a computer software program tangibly contained in a machine readable medium, such as the storage unit 508.

In some embodiments, part or all of the computer program may be loaded and/or installed into the device 500 via the ROM 502 and/or the communication unit 509. When the computer program is loaded into the RAM 503 and executed by the computing unit 501, one or more steps of the image processing method described above may be performed. Alternatively, in other embodiments, the computing unit 501 may be configured to perform the image processing method by any other suitable means (for example, by means of firmware).

Various implementations of the systems and technologies described herein may be implemented in digital electronic circuitry, integrated circuitry, field programmable gate arrays (FPGA), application specific integrated circuits (ASIC), application specific standard products (ASSP), systems on chips (SOC), complex programmable logic devices (CPLD), computer hardware, firmware, software, and/or combinations thereof. The systems and technologies may be implemented in one or more computer programs which are executable and/or interpretable on a programmable system including at least one programmable processor, and the programmable processor may be special or general, and may receive data and instructions from, and transmit data and instructions to, a storage system, at least one input apparatus, and at least one output apparatus.

Program codes for implementing the method according to the present disclosure may be written in any combination of one or more programming languages. These program codes may be provided to a processor or a controller of a general purpose computer, a special purpose computer, or other programmable data processing apparatuses, such that the program code, when executed by the processor or the controller, causes functions/operations specified in the flowchart and/or the block diagram to be implemented. The program code may be executed entirely on a machine, partly on a machine, partly on a machine as a stand-alone software package and partly on a remote machine, or entirely on a remote machine or a server.

In the context of the present disclosure, the machine readable medium may be a tangible medium which may contain or store a program for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the foregoing.

To provide interaction with a user, the systems and technologies described here may be implemented on a computer having: a display apparatus (for example, a cathode ray tube (CRT) or liquid crystal display (LCD) monitor) for displaying information to a user; and a keyboard and a pointing apparatus (for example, a mouse or a trackball) by which a user may provide input for the computer. Other kinds of apparatuses may also be used to provide interaction with a user; for example, feedback provided for a user may be any form of sensory feedback (for example, visual feedback, auditory feedback, or tactile feedback); and input from a user may be received in any form (including acoustic, speech or tactile input).

The systems and technologies described here may be implemented in a computing system (for example, as a data server) which includes a back-end component, or a computing system (for example, an application server) which includes a middleware component, or a computing system (for example, a user computer having a graphical user interface or a web browser through which a user may interact with an implementation of the systems and technologies described here) which includes a front-end component, or a computing system which includes any combination of such back-end, middleware, or front-end components. The components of the system may be interconnected through any form or medium of digital data communication (for example, a communication network). Examples of the communication network include: a local area network (LAN), a wide area network (WAN) and the Internet.

A computer system may include a client and a server. Generally, the client and the server are remote from each other and interact through the communication network. The relationship between the client and the server is generated by virtue of computer programs which run on respective computers and have a client-server relationship to each other. The server may be a cloud server, also called a cloud computing server or a cloud host, and is a host product in a cloud computing service system, so as to overcome the defects of high management difficulty and weak service expansibility in conventional physical host and virtual private server (VPS) service. The server may also be a server of a distributed system, or a server incorporating a blockchain.

It should be understood that various forms of the flows shown above may be used and reordered, and steps may be added or deleted. For example, the steps described in the present application may be executed in parallel, sequentially, or in different orders, which is not limited herein as long as the desired results of the technical solution disclosed in the present disclosure may be achieved.

The above-mentioned implementations are not intended to limit the scope of the present disclosure. It should be understood by those skilled in the art that various modifications, combinations, sub-combinations and substitutions may be made, depending on design requirements and other factors. Any modification, equivalent substitution and improvement made within the spirit and principle of the present disclosure all should be included in the extent of protection of the present disclosure.

What is claimed is:

1. An image processing method, comprising:
acquiring a to-be-processed face image;
reconstructing a face based on the to-be-processed face image to obtain a first blend coefficient vector based on a first blendshape base group;
mapping the first blend coefficient vector to a second blendshape base group according to a pre-obtained coefficient mapping matrix between the first blendshape base group and the second blendshape base group to obtain a second blend coefficient vector based on the second blendshape base group;
acquiring input face adjustment information, the face adjustment information comprising second blendshape base information; and
obtaining a target face image based on the second blendshape base information and the second blend coefficient vector.

2. The method according to claim 1, wherein the second blendshape base group is a semantics-based blendshape base group, and comprises blendshape bases of more than one semantic type.

3. The method according to claim 2, wherein the coefficient mapping matrix is obtained in advance by:
acquiring the preset first blendshape base group and second blendshape base group;
acquiring a first blendshape matrix of the first blendshape base group compared to an average face base and a second blendshape matrix of the second blendshape base group compared to the average face base; and
obtaining the coefficient mapping matrix between the first blendshape base group and the second blendshape base group using the first blendshape matrix and the second blendshape matrix.

4. The method according to claim 1, wherein the acquiring input face adjustment information comprises:
showing selectable second blendshape base information to a user by an interactive interface; and
acquiring the face adjustment information input by the user using the interactive interface, the face adjustment information comprising the second blendshape base information selected by the user.

5. The method according to claim 2, wherein the obtaining a target face image based on the second blendshape base information and the second blend coefficient vector comprises:
determining a semantic type of the second blendshape base information;
updating a coefficient at a position corresponding to the second blendshape base information in the second blend coefficient vector to a valid value, and updating a coefficient at another position corresponding to the determined semantic type in the second blend coefficient vector to an invalid value; and
obtaining the target face image using the updated second blend coefficient vector.

6. An electronic device, comprising:
at least one processor; and
a memory communicatively connected with the at least one processor;
wherein the memory stores instructions executable by the at least one processor, and the instructions are executed by the at least one processor to enable the at least one processor to perform an image processing method, wherein the image processing method comprises:
acquiring a to-be-processed face image;
reconstructing a face based on the to-be-processed face image to obtain a first blend coefficient vector based on a first blendshape base group;
mapping the first blend coefficient vector to a second blendshape base group according to a pre-obtained coefficient mapping matrix between the first blendshape base group and the second blendshape base group to obtain a second blend coefficient vector based on the second blendshape base group;
acquiring input face adjustment information, the face adjustment information comprising second blendshape base information; and
obtaining a target face image based on the second blendshape base information and the second blend coefficient vector.

7. The electronic device according to claim 6, wherein the second blendshape base group is a semantics-based blendshape base group, and comprises blendshape bases of more than one semantic type.

8. The electronic device according to claim 7, wherein the coefficient mapping matrix is obtained in advance by:
acquiring the preset first blendshape base group and second blendshape base group;
acquiring a first blendshape matrix of the first blendshape base group compared to an average face base and a second blendshape matrix of the second blendshape base group compared to the average face base; and
obtaining the coefficient mapping matrix between the first blendshape base group and the second blendshape base group using the first blendshape matrix and the second blendshape matrix.

9. The electronic device according to claim 6, wherein the acquiring input face adjustment information comprises: showing selectable second blendshape base information to a user by an interactive interface; and acquiring the face adjustment information input by the user using the interactive interface, the face adjustment information comprising the second blendshape base information selected by the user.

10. The electronic device according to claim 7, wherein the obtaining a target face image based on the second blendshape base information and the second blend coefficient vector comprises:
determining a semantic type of the second blendshape base information;
updating a coefficient at a position corresponding to the second blendshape base information in the second blend coefficient vector to a valid value, and updating a coefficient at another position corresponding to the determined semantic type in the second blend coefficient vector to an invalid value; and
obtaining the target face image using the updated second blend coefficient vector.

11. A non-transitory computer readable storage medium with computer instructions stored thereon, wherein the computer instructions are used for causing a computer to perform an image processing method, wherein the image processing method comprises:
acquiring a to-be-processed face image;
reconstructing a face based on the to-be-processed face image to obtain a first blend coefficient vector based on a first blendshape base group;
mapping the first blend coefficient vector to a second blendshape base group according to a pre-obtained coefficient mapping matrix between the first blendshape base group and the second blendshape base group to obtain a second blend coefficient vector based on the second blendshape base group;
acquiring input face adjustment information, the face adjustment information comprising second blendshape base information; and
obtaining a target face image based on the second blendshape base information and the second blend coefficient vector.

12. The non-transitory computer readable storage medium according to claim 11, wherein the second blendshape base group is a semantics-based blendshape base group, and comprises blendshape bases of more than one semantic type.

13. The non-transitory computer readable storage medium according to claim 12, wherein the coefficient mapping matrix is obtained in advance by:
acquiring the preset first blendshape base group and second blendshape base group;
acquiring a first blendshape matrix of the first blendshape base group compared to an average face base and a second blendshape matrix of the second blendshape base group compared to the average face base; and
obtaining the coefficient mapping matrix between the first blendshape base group and the second blendshape base group using the first blendshape matrix and the second blendshape matrix.

14. The non-transitory computer readable storage medium according to claim 11, wherein the acquiring input face adjustment information comprises:
showing selectable second blendshape base information to a user by an interactive interface; and
acquiring the face adjustment information input by the user using the interactive interface, the face adjustment information comprising the second blendshape base information selected by the user.

15. The non-transitory computer readable storage medium according to claim 12, wherein the obtaining a target face image based on the second blendshape base information and the second blend coefficient vector comprises:
determining a semantic type of the second blendshape base information;
updating a coefficient at a position corresponding to the second blendshape base information in the second blend coefficient vector to a valid value, and updating a coefficient at another position corresponding to the determined semantic type in the second blend coefficient vector to an invalid value; and
obtaining the target face image using the updated second blend coefficient vector.
